(19) United States
(12) Patent Application Publication
(10) Pub. No.: US 2006/0168298 A1
(43) Pub. Date: Jul. 27, 2006

(54) Desirous scene quickly viewable animation reproduction apparatus, program, and recording medium

(76) Inventors: Shin Aoki, Yokohama-shi (JP); Norihiko Murata, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/304,581

(22) Filed: Dec. 16, 2005

(30) Foreign Application Priority Data
Dec. 17, 2004 (JP) 2004-366862

(51) Int. Cl. G06F 15/16

(52) U.S. Cl. 709/231

(57) ABSTRACT

A video data reproduction apparatus displays an animation on a display by receiving and reproducing video data through streaming data communication. A memory stores index image generated from the video data corresponding to a video display time. The index image represents a part of an image created by the video data. A video playing time changing device changes a current video display time to another. A control device chooses an index image from the memory corresponding to the other video play time, and displays the index image on the display.

### CROSS REFERENCE TO RELATED APPLICATION

This application claims priority under 35 USC §119 to Japanese Patent Application No. 2004-366862 filed on Dec. 17, 2004, the entire contents of which are hereby incorporating by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to an animation reproduction apparatus that reproduces animation data, and in particular to a random video data reproduction technology used in a streaming environment.

2. Discussion of the Background Art

Multimedia data, such as an animation, etc., is becoming widely handled in a calculator due to considerably advantageous random accessing. For example, a user interface named a “seek bar” is employed in a conventional video reproduction software, such as Media Player manufactured by Microsoft Corp, etc., and a playing time is optionally changed by clicking and drugging a seek bar, i.e., a random access is accomplished as shown in FIG. 1. As shown, a video playing region 1 is arranged at an uppermost section of a screen to display a video. A plurality of buttons 4 or the same sort are provided at the bottom section to allow designation of a reproducing or pausing instruction, or the like. A long line horizontally extending almost in the middle section is named a seek bar 2. A square marked on the seek bar 2 is called a marker 3. A length of the seek bar 2 corresponds to a time period of a video to be played, wherein the left end represents a starting time, and the right end, an ending time, respectively. A position of the marker represents a time timed in a currently played video. When a user drugs the marker 3 using a mouse, i.e., he or she points the marker 3, and moves it while depressing a button of the mouse, the marker 3 moves left and right as the mouse moves. A video playing screen simultaneously changes to another scene of a different time corresponding to the marker position. Even though an operation is practically different in accordance with a construction of reproduction program or a type of video data, a playing scene can be updated in real time in response to drugging when uncompressed video data is reproduced by a version 6.4 of the Media Player. If the screen is updated in real time in this manner, a user can preview a desirous scene to watch through the display screen, and can reproduce only the scene by releasing the mouse button there. However, such random accessing is not always available, and is impossible when streaming communication is used by the Media Player.

The streaming generally allows a calculator to start reproducing data recorded on the other one or more calculators connected over the network upon reception of a portion of a data file necessary for the moment without entirely receiving the data file. Such a streaming, however, needs a long time to correspond to a seeking activity as described below. When a user drugs the marker during video playing, the video playing continues as is during the drugging. When the user releases the mouse button at an appropriate position, a reproduction program requests a stream server for transmission of data of a video starting from a time corresponding to the marker position. The stream server stops currently executing transmission of data, and retrieves and transmits the data included in one or more recorded files corresponding to the time of the request. In order to assure a change of a network band, the reproduction program starts reproduction from the requested time after a prescribed amount of data is received in a buffering process. Since both network communications and buffering of a seek instruction are time consuming, a video scene cannot be changed in real time even when the mark is drugged during the streaming reproduction. Specifically, the reproduction needs long time after the mouse button is released.

As one attempt, the Japanese patent application laid open No. (JOP) 2-113790 discusses a technology of starting reproduction from a prescribed time point among recorded video data. Specifically, a plurality of thumbnail images line up as a menu to be selected, and data is reproduced while seeking a time corresponding to the selected thumbnail image. The Japanese patent application laid open No. 2-113790 discusses that a desirous scene is selected by reproducing a thinned image, such as an animation formed by collecting only images of changed scenes, etc., recorded in a hard disk either slowly or in a division multiple manner. The thinned image can be displayed by executing fast-forwarding and rewinding a tape. A video delivery and retrieval system called Media DEPO manufactured by Fuji-Xerox Co., Ltd, includes a slider retrieval function. That is, when a user moves a seek bar, contents of a thumbnail display, named a scene viewer, employed in addition to a video playing screen changes in turn. When a clicking operation is executed thereafter, video playing starts from the time.

According to JOP02-113790, a user interface is formed by displaying a plurality of thumbnail images side by side as a menu to allow random accessing as widely utilized in a DVD or the like. Such a menu displaying manner necessitates a prescribed area for the menu. In particular, the display area becomes larger or other operations, such as menu scrolling, page switching, etc., are necessitated, when a lot of seeking points (i.e., reproduction start times) are employed. JOP6-105280 simply discusses that animation data is recorded in a tape and does not discuss a streaming environment. As mentioned above, JOP2-113790 discusses the scene viewer beside the video screen, and thus, a displaying manner is different from when a un-compression data is reproduced using the above-mentioned media player. Further, it takes long time in transferring data before starting the slider retrieval.

### SUMMARY OF THE INVENTION

Accordingly, an object of the present invention is to improve such background arts and provides a new and novel video data reproduction apparatus that displays an animation by receiving and reproducing video data through streaming communication. Such a new and novel video data reproduction apparatus includes a memory that stores index image generated from the video data corresponding to a video display time. The index image represents apart of an image created by the video data. A video playing time changing device is provided to change a current video display time to another. A control device is provided to choose an index image from the memory corresponding to the other video play time. The control device then displays the index image on the display. In another embodiment, the index image is created by spreading compressed video data into a frame image. In yet another embodiment, a video data transmitting apparatus is connected to the data reproduction apparatus. The video data transmitting apparatus includes an inputting device that inputs video data including a plurality of frames. A recording device is provided to record the video data. An extracting device is provided to extract prescribed frames. A compression device is provided to compress the extracted frames to create an animation.

In yet another embodiment, a reproduction start control device is provided to control video data reproduction to start after receiving the index image.

In yet another embodiment, a determination device is provided to determine a level of significance of the index image. A reception device is provided to receive the index image information in order of the significance.

In yet another embodiment, a transmission device is provided to transmit the index image in order of the significance.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates an exemplary user interface that enables a user to use a typical video reproduction program;

FIG. 2 illustrates an exemplary system of an animation reproduction apparatus of a first embodiment;

FIG. 3 illustrates an exemplary video reproduction program of a second embodiment;

FIG. 4 illustrates exemplary index time data of the first embodiment;

FIG. 5 illustrates an exemplary display screen operated by the reproduction program of the first embodiment;

FIG. 6 illustrates an exemplary initializing sequence executed by the reproduction program of the first embodiment;

FIG. 7 illustrates exemplary index time data employed in the second embodiment;

FIG. 8 illustrates an exemplary portion of a combined index image of the second embodiment;

FIG. 9 illustrates exemplary index time data employed in a third embodiment;

FIG. 10 illustrates an exemplary initializing sequence executed by reproduction program of the third embodiment;

FIG. 11 illustrates exemplary index time data employed in a fourth embodiment;

FIG. 12 illustrates an exemplary initializing sequence executed by reproduction program of the fourth embodiment; and

FIG. 13 illustrates an exemplary initializing sequence executed by reproduction program of a fifth embodiment.

### DESCRIPTION OF THE PREFERRED EMBODIMENTS

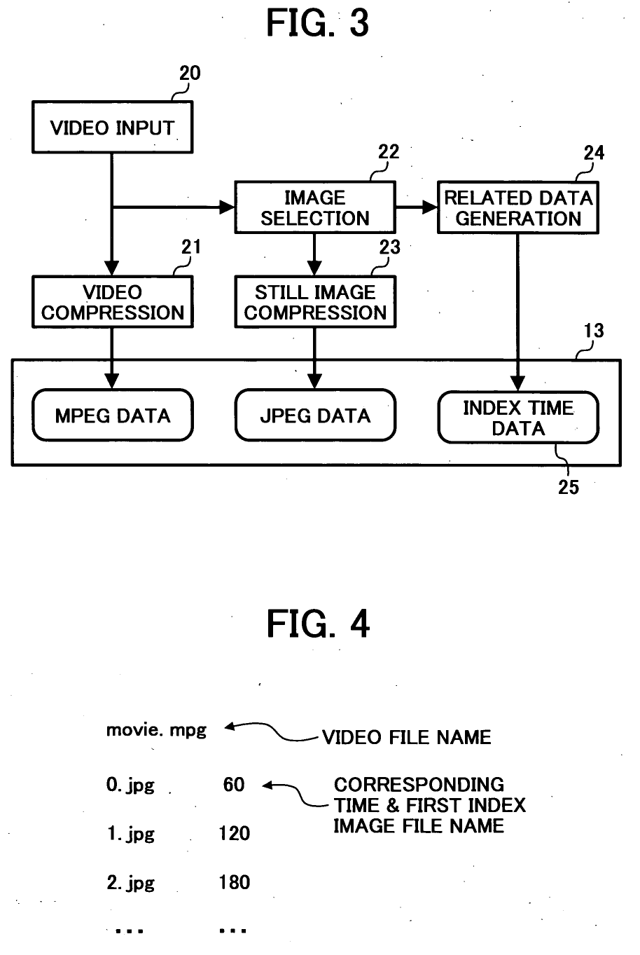

Referring now to the drawing, wherein like reference numerals designate identical or corresponding parts throughout several views, in particular in FIG. 2, an exemplary animation reproduction apparatus according to a first embodiment of the present invention is described. The first embodiment is achieved by executing a prescribed software in a typical personal computer (PC). As shown, the system includes a record delivery PC 11 and a reproduction PC 12 each connected to a network. Each of the PCs 11 and 12 executes program recorded in a hard disk 13 as shown in FIG. 3 using a CPU and a memory or other similar devices. A keyboard 14 and a mouse 15 are connected to the PCs 11 and 12 to accept inputting operations from a user. Further, a CRT display 16 is connected through a video interface circuit (not shown) so as to display an image to a user under program control in each of the PCs 11 and 12. A video camera 17 is connected to the recordation delivery PC 11 through a video input port (not shown) so as to input a video signal to the PC 11.

Re; Recordation Delivery PC Software

Now, configuration and operation of software implemented in a recordation delivery PC 11 are described according to one embodiment of the present invention. The recordation delivery PC 11 executes two programs to generate and deliver data.

Re; Data Generation Program

The data generation program compresses and records video data inputted from the video camera 17 in the hard disk 13. The program simultaneously generates and records a corresponding index image queue. Referring now to FIG. 3, data generation program is described.

Re; Video Input Block 20

The video camera 17 outputs an analog signal in a NTSC format. A video capture board (not shown) included in the PC 11 then converts the analog signal into a digital signal. The program then reads data of the digital signal and generates an image data queue of 30 sheets, each including a pixel size of 320×240, per second.

Re; Video Compression Block 21

The data generation program compresses the digital video data using a known MPEG1 compression algorithm. The video data thus compressed is then recorded in a hard disk included in the PC 11.

Re; Image Selection 22

To form index images, a plurality of frames are extracted from the inputted image data queue at a constant interval every video input per minute (i.e., 1800 frames=30 frames/second×60 seconds).

Re; Still Image Compression 23

The extracted images undergo a compression processing of a known JPEG compression algorithm, and are stored in a hard disk as a file or files. The files are assigned names and serial numbers in order of time.

Re; Index Time Data Generation 25

Simultaneously, information associating the video file with the index image is generated and recorded as index time data as shown in FIG. 4. The index time data constitutes a text file having descriptions of a video file name (on the first line) and index image file names and corresponding times (i.e., time elapsing after video recordation start) (on second and successive lines) The index time data are recorded in appropriate positions (e.g. directories) of the hard disk to be handled by a data transmission program as mentioned later in detail. The index image data may have the same pixel size as the video image data. However, in order to reduce a volume of recordation and transferring data, a reduction processing can be applied before the index time data undergo the JPEG compression. In such a situation, a reproduction program needs to execute expansion processing in order to display in a video playing region.

Re; Data Transmission Program

The data transmission program transmits data generated and recorded by the date generation program through the network in accordance with a request from there production PC 12. The data transfer program handles three categories of data, e.g. video data, index time data, and index image data. Specifically, the video data are transmitted with a streaming protocol. A Media Server manufactured by Microsoft Corp, is utilized as a streaming server program, for example, so that video data recorded in the hard disk can be transmitted in a streaming environment. Both the index time data and index image data are transmitted using a known HTTP protocol. Internet Information Server manufactured by Microsoft Corp, is utilized as a HTTP server program, for example.

Re; Reproduction Program

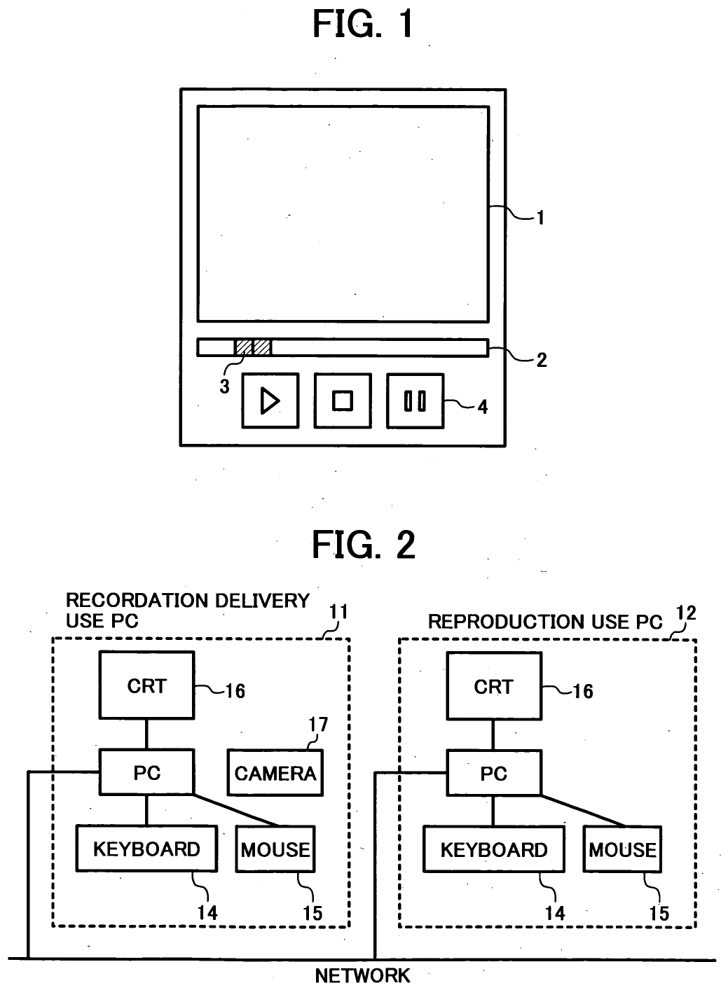

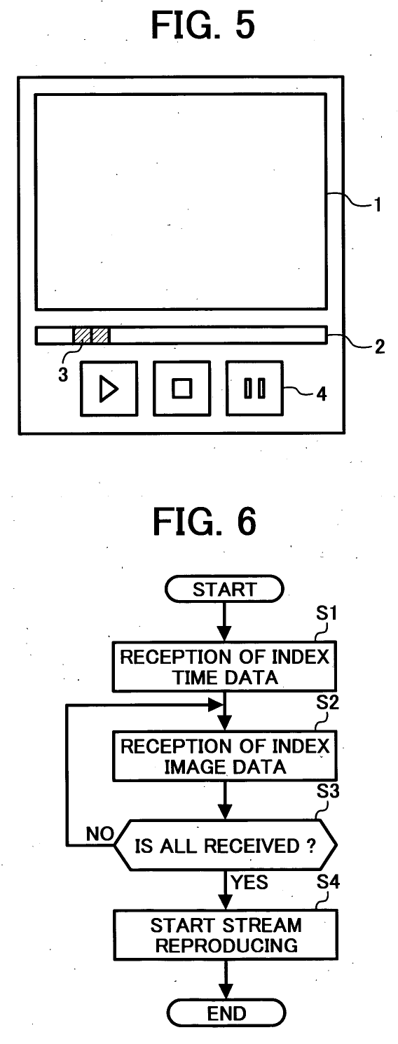

This software runs in a reproduction PC 12 so as to receive data from the recordation delivery PC 12 and display a video in a random access manner in accordance with an instruction from a user. Now, configuration and operation of the software are described with reference to FIG. 5. As shown, a display screen for the software includes a video playing region 1, a seek bar region 2, and a button region (button or the like) 4 in order from the top. The video playing region 1 displays video data and index image data. The seek bar region 2 indicates a time in a video currently being played, or a time to be played. When a user operates the seek bar region 2 with a mouse, contents to be played in the video playing region 1 are changed. The length of the horizontal line indicates the entire time band for the video data being displayed, wherein the left side and right side ends correspond to starting and ending times, respectively. A position of the marker 3 located at a halfway corresponds to a video (or an index image) currently played in the video playing region 1, wherein the position of the marker 3 is represented by it's center vertical line. For example, when video data is one hour long, and the entire seek bar has a width of six hundred pixels, a pixel of the seek bar corresponds to 6 seconds of the video. Further, when the marker positions in a rank of one hundredth pixel from the left side end, it represents that ten minutes have elapsed after starting the video. The button region 4 receives instruct-ions of starting, stopping, and pausing as in a conventional video playing software of FIG. 1.

Re; Initialization

When the program starts in the reproduction PC 12, an initialization processing is executed as mentioned below with reference to FIG. 6.

Re; Index Time Data Reception (S1)

A transmission request for index time data is transmitted to the recordation delivery PC 11, which is previously registered. The index time data is then received and recorded in a memory.

Re; Index Image Data Group Reception (S2)

Transmission of each of still images creating index images is requested with reference to descriptions of the video file names included in the index time data. These are then received and recorded in a memory.

Re; Animation Stream Reception Start (S3)

Transmission of video stream data described in the index time data is requested. Although the recordation delivery PC 11 is previously registered as locations of data to be displayed, data can be chosen from a display list when there are a great number of the data. The video data are received after reception of the still image data in order to utilize an index image when a video is reproduced. However, since reception of the animation practically takes a certain time period in the data streaming environment, it is preferable that a time of requesting animation transmission can be adjusted to be right after requesting the final still image transmission (i.e., before completion of the reception).

Re; Animation Display

When an ordinary streaming video reproduction is executed while receiving video data through the network, contents thereof are displayed on the screen. Further, the marker moves at a prescribed interval (e.g. 1 sec) to a position on the seek bar corresponding to a video time period of current reproduction while the time is displayed on the screen.

When instructions of stopping, starting, and seeking or the like are received through either a button operation or a seek bar operation handler, these operational instructions are then transmitted to the delivery program of the recordation delivery PC 11 through the network, thereby the data transmission operation is requested to change. Such a function can be achieved by a Media Player component manufactured by Microsoft, Corp.

Re; Button Operation Handler

This is called when a mouse click event occurs on the button. Similar to an ordinary video playing software, instructions are issued to an animation display block in order to accomplish functions of starting, stopping, and pausing.

Re; Seek Bar Operation Handler

The below-described operations are performed when mouse button down and up, and drug events occur on the marker.

Re; Button Down

A time designation operation is started as mentioned below. A pausing instruction is issued to an animation display module. A video playing region is prepared by reducing the video playing size into 0×0 pixel (i.e., disappearing). A time corresponding to a current marker position is calculated. A sheet is chosen from the recorded index image group corresponding to the marker time. For example, an index image having the maximum time less than the marker time is preferably chosen, so that an image right before the marker time can be displayed. The thus chosen index image is displayed in the animation display region in the same size as the video.

Re; Drugging

A seek bar marker is moved to a mouse pointer position. A time corresponding to a marker movement destination position is calculated. As in the above-mentioned button down operation, a sheet is chosen from the recorded index image group corresponding to the marker time and is displayed. Since the index image has been separately stored in the reproduction PC 12, and a number thereof is apparently smaller than that of frames of the video data, accessing speed can considerably be higher in comparison with a case when a request is made to a streaming server or compression data using a correlation of frames is spread.

Re; Button Up

An animation display module is instructed to seek a time corresponding to a current marker position. After the seeking and buffering complete, an index image is erased and a video playing size is returned to the original size. Then, video reproduction restarts.

Re; Exemplary Operations

Herein below, an exemplary operation of a system in connection with a user operation is described. It is supposed that recordation program is completed in the recordation delivery PC 11, i.e., data to deliver has already been recorded in the hard disk.

Re; Starting Up

When started by a user, a display program attempts to execute a network communication with a recordation delivery PC 11 and receives an index time data. After that, the display program receives and records an index image group, and starts executing streaming video communications.

Re; Reproduction Starts

After buffering of streaming data, a video starts being played on a screen.

Re; Seek Operation

A user operates a seek bar with a mouse during the video playing.

Re; Pushing a Button on a Marker

The video playing is terminated at a time, while a still image in the vicinity of the time is displayed. As the drugging mouse cursor moves left and right as is, the marker similarly moves. Substantially simultaneously, a still image in the vicinity of a time corresponding to the marker is displayed in the video playing region. Even though, the still image has less number of frames in comparison with that of the video (1 sheet/minute) contents can be roughly guessed.

Re; Take Off Button

The last index image is continuously displayed for a while at this time. However, video reproduction is restarted from a time corresponding to the marker position thereafter.

A great number of image data is utilized as index images in the first embodiment. Ina second embodiment, however, a plurality of index image data are arranged in a form of a sheet to be recorded and communicated. Now, only differences from the first embodiment are described.

Re; Data Generation Program

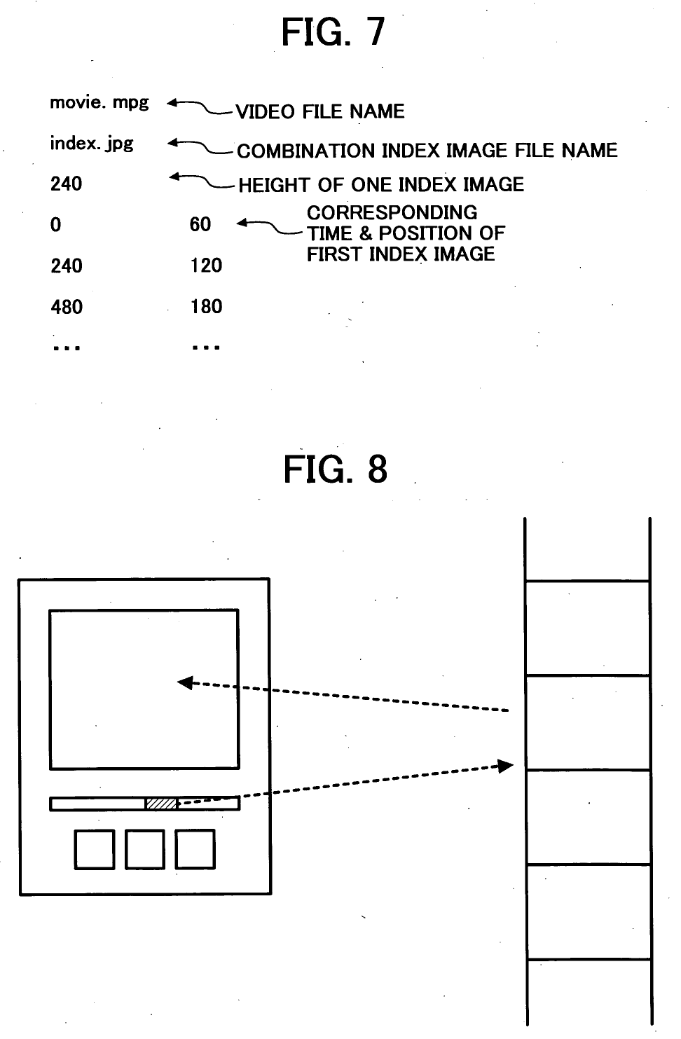

The recordation delivery PC 11 vertically arranges and combines index images generated by the video recordation in a large sheet image. Further, a video data file name, a combined index image filename, a height of a sheet of an original index image, positions and corresponding times of index images on the combined index image (e.g. a distance from the upper most end) are generated and recorded as index time data as shown in FIG. 7.

Re; Reproduction Program

The reproduction program reads a name of a combined index image file from the index time data file, and transmits a transmission request for the combined index image file to the delivery PC 11. Then, the reproduction program receives and stores contents thereof. As mentioned earlier, a corresponding index image is selectively displayed in response to the drugging of the seek bar in the first embodiment. However, a corresponding portion of the combined index image is extracted and displayed in the second embodiment. Specifically, a corresponding index image number is calculated based on a moved position of the seek bar. Then, a corresponding region on the combined index image is calculated based on the index time data. Then, the region is extracted and displayed on the video playing region as shown in FIG. 8.

In a third embodiment, index image data is compressed in a prescribed manner and delivered as an animation. Specifically, the reproduction PC 12 receives and requests the index data and handles respective frames as index images. Since there is highly provably a strong correlation between frames, especially when taken by a fixed camera for monitoring, data capacity can be reduced if a prescribed animation compression algorithm is utilized. Thus, a transfer time required in transferring the index information, accordingly, a time period from when a user provides an instruction to when animation is practically reproduced can be reduced.

Herein below, differences from the first embodiment are described.

Re; Recordation Program

The recordation delivery PC 11 combines index images generated by video recordation side by side, and processes and handles those as an animation. The recordation delivery PC 11 then compresses these index images with MPEG1 compression algorithm and records those as a file.

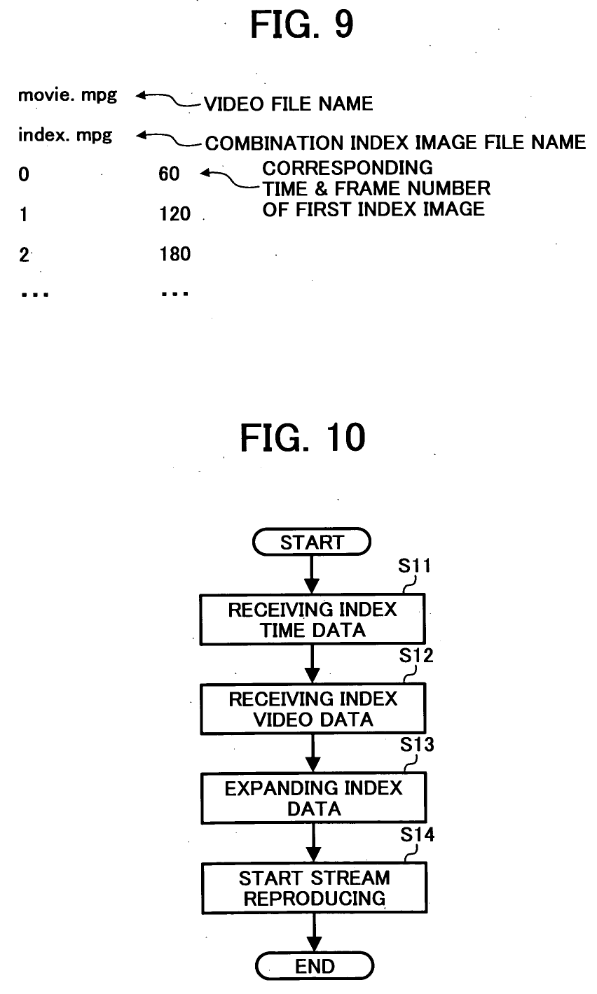

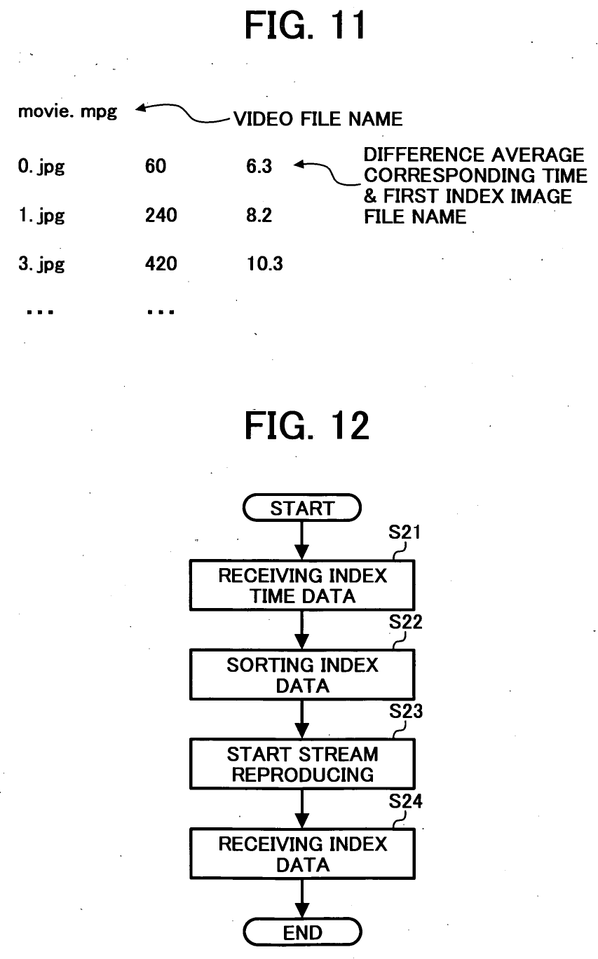

The recordation delivery PC 11 generates video data of a main context and an index, a frame number of each of the index video data, and a corresponding time as index time data as shown in FIG. 9.

Re; Reproduction Program

The reproduction program receives and spreads the compressed index image video file in an initialization processing, and stores each frame as an individual image in a memory in steps S11 to S14 in FIG. 10.

Then, the index image is handled in a similar manner as in the first embodiment.

The frame image becomes the index image at a prescribed time interval in the first embodiment. However, only a frame-having changed is used as an index image to help retrieve in a fourth embodiment. Further, an animation is enabled to be roughly displayed even right after being started. Specifically, the index image is received in order from that having changed at most together with a streaming video.

Re; Recordation Program

An index still image is generated considering a difference between the frame images. In the first embodiment, frame images are extracted every one minute. However, they are not always made into index images in this embodiment. Specifically, a difference between each of the entire pixels in a screen of a frame image and that of a right before frame image (i.e., one minute before) is calculated, and such absolutes are averaged. Only frames having averages larger than a prescribed threshold are utilized as index images. For example, when 256 gradation data is used, only a frame having an average of a differential absolute larger than 5 is used as an index image. Further, the differential average is recorded in the index time data per index image.

Re; Reproduction Program

After index time data is received, index images are sorted in descending order of the differential average thereof after the sorting in the initialization processing. A transmission request is then made in order of largeness of the differential average and applicable index images are received. A streaming animation reproduction is started right before the transmission request. The animation reproduction module executes a video reproduction processing in parallel with index image data reception thereafter. When a seek bar operation starts before reception of the entire index images, a scene on a screen is updated using the index images having been received until the time. Specifically, an index image having the maximum time less than a time corresponding to the marker moving position is selected among the index images already received and is displayed Thus, video reproduction can be started without waiting reception of the entire index images after the program starts. Further, since the index images are received and used from that having the largest change in steps S21 to S24 of FIG. 12, a change in video can be roughly represented without receiving the entire image.

In a fourth embodiment, the transmission order of index images is determined based on the request from the reproduction PC 12. However, the recordation delivery PC 11 determines the transmission order in a fifth embodiment.

Re; Recordation Program

As in the fourth embodiment, an index image is selected and recorded based on an average of differential absolutes. After video recordation is completed, index images are sorted by the differential average similar to the reproduction program of the fourth embodiment. The index images are handled as frames in order from that having the largest differential average. Then, the entire frames undergo MPEG compression to be an animation. Similar index time data are employed to that in the third embodiment. However, corresponding times are not limited to be in ascending order.

Re; Reproduction Program

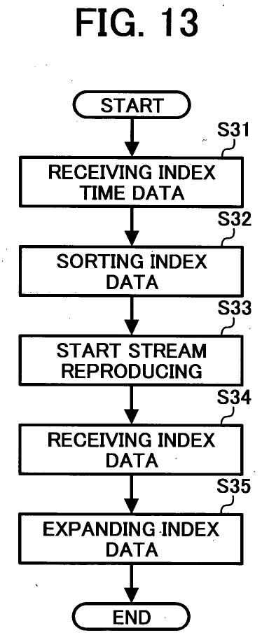

As in the fourth embodiment, streaming reproduction starts before completion of reception of index (video) data. The MPEG data is processed by compression algorithm using a difference between frames. However, these data are restorable in a unit called GOP (Group of picture). Then, a part of the data capable of spreading is processed during the reception of the index (video) data and is utilized as an index image display in steps S31 to S35 of FIG. 13 as in the forth embodiment.

Numerous additional modifications and variations of the present invention are possible in light of the above teachings. It is therefore to be understood that within the scope of the appended claims, the present invention may be practiced otherwise that as specifically described herein.

1-8. (canceled)

9. An animation reproduction apparatus connected to a network, said animation reproduction apparatus comprising:
a video data receiving device configured to receive video data over the network in a streaming environment;
a video data reproducing device configured to reproduce the video data to play an animation;
a memory configured to store at least two index image information, said at least two index image information being generated by extracting the video data at a prescribed time interval and representing a scene of the animation, each of said at least two index image information including a video playing time;
a display device configured to display a scene based on index image information on a display region;
a video display time designation device configured to designate a different video display time; and
a choosing device configured to choose index image information from the memory to display another scene in correspondence with the designated video display time.

10. The animation reproduction apparatus as claimed in claim 9, wherein said memory receives compressed video data in a form of a frame image, said memory spreading and storing the compressed video data as an index image.

11. An animation providing apparatus connected to a network, said animation providing apparatus comprising:
a take in device configured to take in a video signal;
a recording device configured to record the video signal in a form of a frame;
a choosing device configured to choose at least two frame images from the video signals; and
a compression recordation device configured to compress and record the frame images as an animation, said frame image being transmitted over the network.

12. The animation reproduction apparatus as claimed in claim 9, further comprising a start control device configured to control the animation to be started after the index image information has been received.

13. The animation reproduction apparatus as claimed in claim 9, further comprising:
a weighing device configured to weigh the index images; and
a reception control device configured to receive the index images in order of the weight.

14. The animation providing apparatus as claimed in claim 11, further comprising:
a weighing device configured to weigh the index images; and
a transmission control device configured to transmit the index images in order of the weight.

15. A computer program product including computer readable code which when executed causes a processor to execute one or more functions of the animation reproduction apparatus as claimed in claim 14.

16. A computer-usable medium including computer readable code which when executed causes a processor to execute one or more functions of the animation reproduction apparatus as claimed in claim 14.
